(19) United States
(12) Patent Application Publication
(10) Pub. No.: US 2020/0050078 A1
(43) Pub. Date: Feb. 13, 2020

(54) FOCAL PLANE SHUTTER, AND IMAGING DEVICE EQUIPPED WITH SAME

(71) Applicant: NIDEC COPAL CORPORATION, Tokyo (JP)

(72) Inventor: Yusuke SUZUKI, Tokyo (JP)

(73) Assignee: NIDEC COPAL CORPORATION, Tokyo (JP)

(21) Appl. No.: 16/497,836

(22) PCT Filed: Mar. 30, 2018
(86) PCT No.: PCT/JP2018/013565

§ 371 Date: Sep. 26, 2019

(30) Foreign Application Priority Data
Mar. 31, 2017 (JP) 2017-071949

(51) Int. Cl. G03B 9/40

(52) U.S. Cl. CPC G03B 9/40

(57) ABSTRACT

A focal plane shutter has a front blade and a rear blade for opening/closing an exposure opening formed in a shutter base plate; a front blade first driving member that is coupled to the front blade and a rear blade first driving member that is coupled to the rear blade; and a first electromagnetic actuator for driving the front blade first driving member and a second electromagnetic actuator for driving the rear blade first driving member.

### CROSS-REFERENCE TO RELATED APPLICATIONS

This Application is the National Stage of International Application No. PCT/JP2018/013565 filed Mar. 30, 2018 which in turn claims priority to Japanese Application No. 2017-071949 filed Mar. 31, 2017. All of the applications are incorporated herein by reference.

### FIELD OF TECHNOLOGY

The present invention relates to a focal plane shutter and to an imaging device equipped therewith.

### BACKGROUND

Among focal plane shutters that are installed in imaging devices, such as digital cameras, those that are configured so as to hold a driving member in a position for starting an exposing operation (a setting position) are of a structure known as the “direct type.” The direct type is structured through holding the driving member in the setting position through an electromagnet attracting an iron piece member of the driving member.

Moreover, focal plane shutters can be operated in three different modes, a normally-open mode, a normally-closed mode, and a front curtain electronic shutter mode. The blade driving mechanism for a focal plane shutter that operates in these three different modes is structured from a first driving member that is coupled to a blade, and a second driving member that, through a biasing force of a driving spring (a biasing member), causes the first driving member to follow. In the front blade driving mechanism, when the release button of the imaging device is pressed, first the front blade is caused to move to the setting position through the first driving member rotating in the set direction through the biasing force of a set spring (a biasing member). Following this, the second driving member rotates, along with the first driving member, in the direction that is opposite of the setting direction, through the biasing force of a driving spring. Through this, the front blade is caused to travel from the setting position to the position wherein the exposing operation is completed.

For example, Japanese Unexamined Patent Application Publication 2011-113060 discloses a focal plane shutter wherein the blade is driven through the use of the attracting force of an electromagnet and the biasing force of a biasing spring.

For the second driving member to rotate along with the first driving member, the biasing force of the driving spring for biasing the second driving member must be stronger than the biasing force of the set spring for biasing the first driving member. Moreover, the second driving member may be caused to move more quickly in order to increase the speed of continuous shooting and increase the speed of the shutter, and the like, in an imaging device. Increasing the speed of travel of the second driving member necessitates, for example, a stronger biasing force for the driving spring.

However, if the biasing force of the driving spring is strong, then the attracting force (magnetic force) of the electromagnet for holding the second driving member at the position for starting the exposing operation must be strong as well. Increasing the attracting force of the electromagnet requires the electromagnet to be larger, requires that more power be supplied to the electromagnet, or the like. An increase in size of the electromagnet, and an increase in the amount of power supplied thereto, may lead to a larger focal plane shutter, and greater electric power consumption.

In consideration of the facts set forth above, the object of the present invention is to provide a focal plane shutter, and an imaging device equipped therewith, able to improve performance of the shutter, without increasing the biasing force of the biasing member and the attracting force of the electromagnet.

### SUMMARY

In order to achieve the object set forth above, the focal plane shutter according to the present invention includes a blade member for opening/closing an exposure opening that is formed in a base plate; a first driving member that is coupled to the blade member; and an electromagnetic actuator for driving the first driving member.

Given this structure, in the focal plane shutter according to the present invention, the electromagnetic actuator drives the first driving member, enabling the blade member to be actuated without the presence of a biasing spring on the first driving member that is connected to the blade member. Consequently, the focal plane shutter according to the present invention is able to improve shutter performance without increasing the strength of the biasing force of the biasing member and the strength of the attracting force of the electromagnet.

The focal plane shutter may further have

a second driving member for rotating, along with the first driving member, through the biasing force of a driving spring; and
a setting member for the setting the second driving member to a position for starting the exposing operation, against the biasing force of the driving spring.

The electromagnetic actuator may be configured so as to link the first driving member to actuation of the second driving member and the setting member.

The electromagnetic actuator may be structured so as to be coupled to the first driving member through one or more gears.

The focal plane shutter may further have a position sensor for detecting a rotational position of the one or more gears.

Moreover, an imaging device according to the present invention is equipped with the focal plane shutter described above.

An imaging device according to the present invention includes a focal plane shutter equipped with the position sensor; and a controlling portion for controlling the speed of movement of the blade member based on the rotational position detected by the position sensor.

The present invention enables provision of a focal plane shutter, and an imaging device equipped therewith, able to improve performance of the shutter, without increasing the biasing force of the biasing member and the attracting force of the electromagnet.

### BRIEF DESCRIPTIONS OF THE DRAWINGS

FIG. 1 is a block diagram illustrating the structure of an imaging device equipped with a focal plane shutter according to first and second examples according to the present invention.

FIG. 2 is a diagram depicting the initial state, and the like, when imaging in the normally-closed mode of a focal plane shutter according to the first example according to the present invention.

FIG. 3 is a diagram depicting the state when the exposing operation has been completed, or the like, in imaging in the normally-closed mode.

FIG. 4 is a diagram depicting the initial state, and the like, when imaging in the normally-open mode.

FIG. 5 is a diagram depicting the state when the actuation of the front blade exposing operation has been completed, or the like, in imaging in the normally-open mode.

FIG. 6 is a diagram depicting the state when the actuation of the rear blade exposing operation has been completed, or the like, in imaging in the normally-open mode.

FIG. 7 is a diagram depicting the state when the setting operation by the setting member has been completed in a second driving mode.

FIG. 8 is a diagram depicting the state when the setting member has been retracted in the second driving mode.

FIG. 9A is a structural diagram of a first electromagnetic actuator.

FIG. 9B is a structural diagram of a second electromagnetic actuator.

FIG. 10 is a diagram depicting a focal plane shutter according to a second example according to the present invention.

FIG. 11 is a schematic diagram depicting a follower gear and a position sensor.

### DETAILED DESCRIPTION

Focal plane shutters according to examples according to the present invention will be explained below in reference to the drawings.

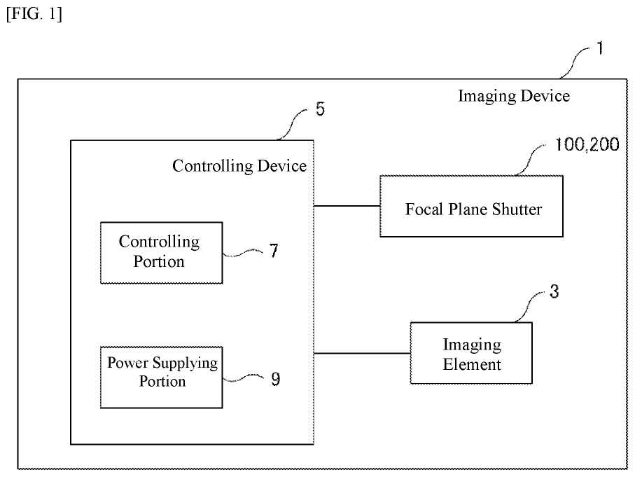

A focal plane shutter 100 according to and example according to the present invention is provided in an imaging device 1 that has an imaging element 3, a controlling device 5, and the like, as illustrated in FIG. 1. The imaging device 1 is, for example, a camera or a monitoring camera, which may be a digital camera, or the like. The imaging element 3 is an image sensor such as a CCD (charge-coupled device), a CMOS (complementary metal oxide semiconductor), or the like. The controlling device 5 has a controlling portion 7 and a power supplying portion 9. The controlling portion 7 controls the various portions of the imaging device 1. The controlling portion 7 has a CPU (central processing unit), a memory, a timer, and the like. The power supplying portion 9 supplies electric power (which may also be termed “electric current,” below) to the various portions of the imaging device 1.

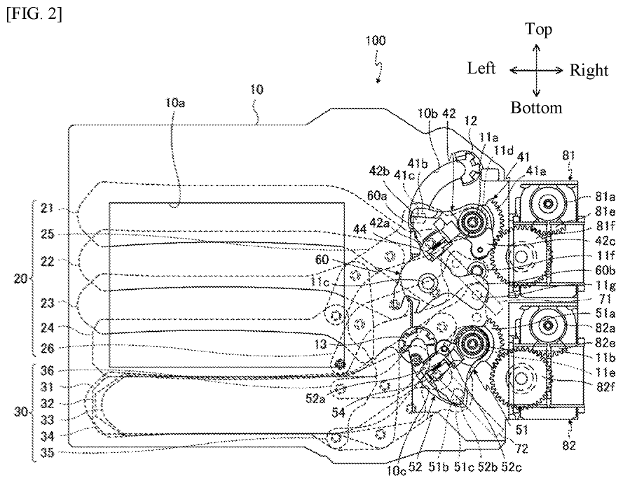

The structure of the focal plane shutter 100 according to the present example will be explained first in reference to FIG. 2 through FIG. 9B. Note that in the explanation, the front face side (the front side) in FIG. 2 is defined as the imaging subject side (the imaging lens side), and the back face side in FIG. 2 is defined as the imaging element 3 side.

The focal plane shutter 100 according to the present example, as illustrated in FIG. 2 through FIG. 8, has a shutter base plate 10; a front blade 20; a rear blade 30; a first driving member 41 for the front blade; a second driving member 42 for the front blade; a first driving member 51 for the rear blade; a second driving member 52 for the rear blade; a setting member 60; an electromagnet 71 for the front blade; an electromagnet 72 for the rear blade; a first electromagnetic actuator 81; and a second electromagnetic actuator 82.

The shutter base plate 10 is formed from synthetic resin, or the like, in an essentially rectangular flat plate shape. An exposure opening 10a, which is a rectangle that is long in the crosswise direction, is formed in essentially the center portion of the shutter base plate 10. Additionally, a middle plate (not shown) for defining a blade chamber for containing the front blade 20, and a supplementary base plate (not shown) for defining a blade chamber for containing the rear blade 30 are provided with prescribed spacing on the back face side of the shutter base plate 10. An opening of a shape that is similar to the shape of the exposure opening 10a is formed in essentially the center portions of the middle plate and the supplementary base plate. The shape of the exposure opening for allowing passage of light from the imaging subject is formed through superimposition of these openings and the exposure opening 10a. In the present example, the explanation will assume that the shape of the exposure opening that allows passage of light from the imaging subject and the shape of the exposure opening 10a are identical.

Two arc-shaped elongated holes 10b and 10c are formed in a region on the right side of the exposure opening 10a of the shutter base plate 10. Additionally, a shock absorbing material 12 and a shock absorbing material 13 are attached respectively to the respective top ends of the elongated hole 10b and of the elongated hole 10c. The shock absorbing material 12 and the shock absorbing material 13 may be formed in an essentially C shape from rubber. Elongated holes of essentially identical shapes as the elongated holes 10b and 10c are formed in regions, of the supplementary base plate, that overlap with the elongated holes 10b and 10c, and regions of the middle plate that overlap with the elongated holes 10b and 10c.

Supporting shafts 11a, 11b, and 11c are provided protruding on the front face, that is, on the face on the imaging subject side, of the shutter base plate 10. Additionally, supporting shafts 11d, 11e, 11f, and 11g are provided protruding from the back face, that is, the face on the imaging element 3 side, of the shutter base plate 10. The supporting shaft 11d and the supporting shaft 11a are provided concentrically. The supporting shaft 11e and the supporting shaft 11b are provided concentrically.

Note that another plurality of shafts is provided protruding on the front face of the shutter base plate 10. At the tip end portions of these shafts a supporting plate (not shown) and a printed circuit board (not shown) are provided sequentially from the shutter base plate 10 side.

The front blade 20 is a mechanical front curtain shutter (blade member). The front blade 20 moves (travels) in a blade chamber between the shutter base plate 10 and the middle plate. The front blade 20 is structured from an arm 25, an arm 26, and four blades 21, 22, 23, and 24. One end of the arm 25 is attached rotatably to the supporting shaft 11d. One end of the arm 26 is attached rotatably to the supporting shaft 11f. The four blades 21 through 24 are supported so as to be able to pivot, sequentially towards the free ends of the arms 25 and 26, which are the other ends. Here the blade 24 is a slitted blade, having an exposure slit formed therein. Moreover, a tip end portion of a driving pin 41c of a first driving member 41 for the front blade, described below, fits into an elongated hole (not shown) that is formed in the arm 25.

The rear blade 30 is a mechanical back curtain shutter (blade member). The rear blade 30 moves (travels) in a blade chamber between the middle plate and the supplementary plate. The rear blade 30 is structured from an arm 35, an arm 36, and four blades 31, 32, 33, and 34. One end of the arm 35 is attached rotatably to the supporting shaft 11e. One end of the arm 36 is attached rotatably to the supporting shaft 11g. The four blades 31 through 34 are supported so as to be able to pivot, sequentially towards the free ends of the arms 35 and 36, which are the other ends. Here the blade 34 is a slitted blade, having an exposure slit formed therein. Moreover, a tip end portion of a driving pin 51c of a first driving member 51 for the rear blade, described below, fits into an elongated hole (not shown) that is formed in the arm 35.

The front blade first driving member 41 is a member for opening/closing the exposure opening 10a of the front blade 20 through rotating in the clockwise or counterclockwise direction. The front blade first driving member 41 is coupled to the front blade 20. Additionally, the front blade first driving member 41 is attached rotatably to the supporting shaft 11a. The front blade first driving member 41 has a mating portion 41a, a pushed portion 41b, and a driving pin 41c.

The mating portion 41a of the front blade first driving member 41 is a fan-shaped position wherein gear teeth are arranged in an arc shape. The mating portion 41a meshes with a follower gear 81f of a first electromagnetic actuator 81, described below. Consequently, the front blade first driving member 41 is structured so as to rotate following the rotation of the follower gear 81f.

The pushed portion 41b of the front blade first driving member 41 is a position that is formed wherein a portion of the front face side of the tip end portion of the front blade first driving member 41 is protruding so as to be able to contact a pushing portion 42b of a front blade second driving member 42, described below. The pushed portion 41b is pushed by a pushing portion 42b, when the front blade second driving member 42 is rotated in the clockwise direction by the biasing force of a driving spring for the front blade. The front blade first driving member 41 is rotated in the clockwise direction, following the front blade second driving member 42 thereby.

A driving pin 41c of the front blade first driving member 41 is disposed in the back face side of the tip end portion of the front blade first driving member 41. The driving pin 41c is inserted into the elongated hole 10b of the shutter base plate 10. The tip end portion of the driving pin 41c is fitted into an elongated hole that is formed in the arm 25. Through this, the front blade first driving member 41 is coupled to the front blade 20 within the blade chamber between the shutter base plate 10 and the middle plate. Moreover, the base end portion of the driving pin 41c is formed with an essentially circular cross-sectional shape. The base end portion of the driving pin 41c contacts the shock absorbing material 12 that is provided at the bottom end of the elongated hole 10b.

The front blade second driving member 42 is a member for moving the front blade 20 so as to open the exposure opening 10a. The front blade second driving member 42 causes the front blade 20 to move, through rotating following the front blade first driving member 41. The front blade second driving member 42, as with the front blade first driving member 41, is attached rotatably to the supporting shaft 11a. The front blade second driving member 42, in the exposing operation of the front blade 20, is rotated in the clockwise direction, together with the front blade first driving member 41, by the biasing force (second biasing force) of a front blade driving spring. The clockwise rotation of the front blade second driving member 42 is stopped when the driving pin 41c of the front blade first driving member 41 contacts the shock absorbing material 12. The front blade second driving member 42 has an attaching portion 42a, a pushing portion 42b, and an engaged portion 42c.

The attaching portion 42a of the front blade second driving member 42 is formed so as to be thick on the front side of the front blade second driving member 42. The attaching portion 42a is a site for attaching an iron piece member 44 through a compression spring (not shown) in the interior thereof. The iron piece member 44 fits with the attaching portion 42a so as to be held on the front blade electromagnet 71, through a well-known structure.

The front blade second driving member 42 pushing portion 42b is a site that is cut away into a shape corresponding to the shape of the pushed portion 41b, so as to enable contact with the pushed portion 41b of the front blade first driving member 41. When the front blade second driving member 42 is rotated in the clockwise direction by the biasing force of the front blade driving spring, the pushing portion 42b makes contact with the pushed portion 41b, to push the pushed portion 41b. The front blade second driving member 42 rotates in the clockwise direction together with the front blade first driving member 41 thereby.

The front blade second driving member 42 engaged portion 42c is a site that is engaged with the first engaging portion 60a of a setting member 60. When the setting member 60 rotates in the clockwise direction, the engaged portion 42c is pushed while making sliding contact with the first engaging portion 60a. Through this, the front blade second driving member 42 is rotated in the counterclockwise direction against the biasing force of the front blade driving spring. When the setting member 60 stops the clockwise rotation, the engaged portion 42c is engaged by the first engaging portion 60a. The clockwise rotation of the front blade second driving member 42 by the biasing force of the front blade driving spring is restrained thereby.

The rear blade first driving member 51 is a member for opening/closing the exposure opening 10a of the rear blade 30 through rotating in the clockwise or counterclockwise direction. The rear blade first driving member 51 is coupled to the rear blade 30. Additionally, the rear blade first driving member 51 is attached rotatably to the supporting shaft 11b. The rear blade first driving member 51 has a mating portion 51a, a pushed portion 51b, and a driving pin 51c.

The mating portion 51a of the rear blade first driving member 51 is a fan-shaped position wherein gear teeth are arranged in an arc shape. The mating portion 51a meshes with a follower gear 82f of a second electromagnetic actuator 82, described below. Consequently, the rear blade first driving member 51 is structured so as to rotate following the rotation of the follower gear 82f.

The pushed portion 51b of the rear blade first driving member 51 is a site that contacts a pushing portion 52b of a rear blade second driving member 52, described below. The pushed portion 51b is pushed by a pushing portion 52b, when the rear blade second driving member 52 is rotated in the clockwise direction by the biasing force of a driving spring for the rear blade. The rear blade first driving member 51 is rotated in the clockwise direction, following the rear blade second driving member 52 thereby.

A driving pin 51c of the rear blade first driving member 51 is disposed in the back face side of the tip end portion of the rear blade first driving member 51. The driving pin 51c is inserted into the elongated hole 10c of the shutter base plate 10. The tip end portion of the driving pin 51c is fitted into an elongated hole that is formed in the arm 35. Through this, the rear blade first driving member 51 is coupled to the rear blade 30 within the blade chamber between the shutter base plate 10 and the middle plate. Moreover, the base end portion of the driving pin 51c is formed with an essentially circular cross-sectional shape. The base end portion of the driving pin 51c contacts the shock absorbing material 13 that is provided at the bottom end of the elongated hole 10c.

The rear blade second driving member 52 is a member for moving the rear blade 30 so as to close the exposure opening 10a. The rear blade second driving member 52 causes the rear blade 30 to move, through rotating following the rear blade first driving member 51. The rear blade second driving member 52, as with the rear blade first driving member 51, is attached rotatably to the supporting shaft 11b. The rear blade second driving member 52, in the exposing operation of the rear blade 30, is rotated in the clockwise direction, together with the rear blade first driving member 51, by the biasing force of a rear blade driving spring. The clockwise rotation of the rear blade second driving member 52 is stopped when the driving pin 51c of the rear blade first driving member 51 contacts the shock absorbing material 13. The rear blade second driving member 52 has an attaching portion 52a, a pushing portion 52b, and an engaged portion 52c.

The attaching portion 52a of the rear blade second driving member 52 is formed so as to be thick on the front side of the rear blade second driving member 52. The attaching portion 52a is a site for attaching an iron piece member 54 through a compression spring (not shown) in the interior thereof. The iron piece member 54 fits with the attaching portion 52a so as to be held on the rear blade electromagnet 72, through a well-known structure.

The pushing portion 52b of the rear blade second driving member 52 is a site that is formed through having a portion of the back face side of the rear blade second driving member 52 protruding, so as to enable contact with the pushed portion 51b of the rear blade first driving member 51. When the rear blade second driving member 52 is rotated in the clockwise direction by the biasing force of the rear blade driving spring, the pushing portion 52b makes contact with the pushed portion 51b, to push the pushed portion 51b. The rear blade second driving member 52 rotates in the clockwise direction together with the rear blade first driving member 51 thereby.

The rear blade second driving member 52 engaged portion 52c is a site that is engaged with the second engaging portion 60b of a setting member 60. When the setting member 60 rotates in the clockwise direction, the engaged portion 52c is pushed while making sliding contact with the second engaging portion 60b. Through this, the rear blade second driving member 52 is rotated in the counterclockwise direction against the biasing force of the rear blade driving spring. When the setting member 60 stops the clockwise rotation, the engaged portion 52c is engaged by the second engaging portion 60b. The clockwise rotation of the rear blade second driving member 52 by the biasing force of the rear blade driving spring is restrained thereby.

The setting member 60 is a member for setting, to a setting position (the position prior to the beginning of the exposing operation), the front blade second driving member 42 and the rear blade second driving member 52. The setting member 60 is attached rotatably to a supporting shaft 11c. The setting member 60 is biased so as to rotate in the counterclockwise direction by a biasing spring (not shown). The setting member 60 has a first engaging portion 60a and a second engaging portion 60b.

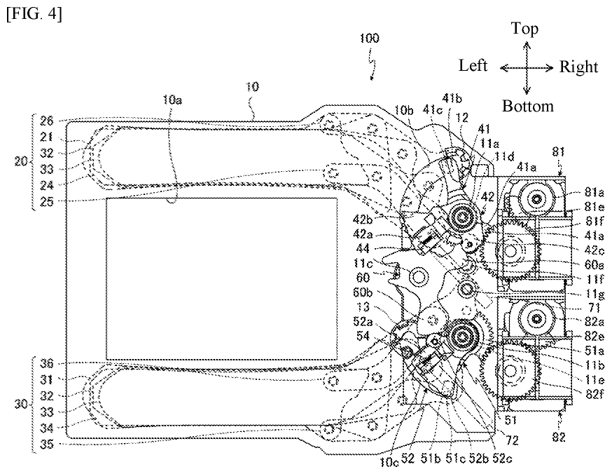

The setting member 60 carries out a setting operation to set, to the setting position, the front blade second driving member 42 and the rear blade second driving member 52 through rotation in the clockwise direction from the initial position depicted in FIG. 2, and the like (the position in the state wherein the exposing operation has been completed). The setting member 60 is rotated in the clockwise direction through the driving force of a driving mechanism (not shown) of the imaging device 1. In the setting operation, the first engaging portion 60a pushes, while making sliding contact with, the engaged portion 42c of the front blade second driving member 42, to rotate the front blade second driving member 42 in the counterclockwise direction, to set it into the setting position. Additionally, the second engaging portion 60b, through pushing, while making sliding contact with, the engaged portion 52c of the rear blade second driving member 52, rotates the rear blade second driving member 52 in the counterclockwise direction, to set it into the setting position. When the setting operation has been completed, the setting member 60 is pressed by a driving mechanism of the imaging device 1. Through this, the setting member 60 is held in the setting position, as depicted in FIG. 4, and the like. When the pushing by the driving mechanism of the imaging device 1 is released, the setting member 60 is rotated in the counterclockwise direction by the biasing force of the biasing spring, to return from the setting position to the initial position. In the state wherein the front blade second driving member 42 and the rear blade second driving member 52 are held by the front blade electromagnet 71 and the rear blade electromagnet 72, the first engaging portion 60a will retract from the engaged portion 42c of the front blade second driving member 42, through the setting member 60 being returned from the setting position to the initial position. Additionally, the second engaging portion 60b will withdraw from the engaged portion 52c of the rear blade second driving member 52. This allows the clockwise rotation of the front blade second driving member 42 and the rear blade second driving member 52.

In the setting operation, the first engaging portion 60a of the setting member 60 is a site for engaging the engaged portion 42c of the front blade second driving member 42. When the setting member 60 rotates in the clockwise direction, the first engaging portion 60a pushes, while making sliding contact with, the engaged portion 42c. The first engaging portion 60a rotates the front blade second driving member 42 in the counterclockwise direction against the biasing force of a front blade driving spring. Additionally, when the clockwise rotation of the setting member 60 is stopped, the first engaging portion 60a restrains the clockwise rotation of the front blade second driving member 42 through engaging the engaged portion 42c.

In the setting operation, the second engaging portion 60b of the setting member 60 is a site for engaging the engaged portion 52c of the rear blade second driving member 52. When the setting member 60 rotates in the clockwise direction, the second engaging portion 60b pushes, while making sliding contact with, the engaged portion 52c. The second engaging portion 60b rotates the rear blade second driving member 52 in the counterclockwise direction against the biasing force of a rear blade driving spring. Additionally, when the clockwise rotation of the setting member 60 is stopped, the second engaging portion 60b restrains the clockwise rotation of the rear blade second driving member 52 through engaging the engaged portion 52c.

The front blade electromagnet 71 is a member for holding the front blade second driving member 42 in the setting position. Additionally, the rear blade electromagnet 72 is a member for holding the rear blade second driving member 52 in the setting position. The front blade electromagnet 71 and the rear blade electromagnet 72 are provided on the supporting plate, described above. The front blade electromagnet 71 contacts the iron piece member 44 of the front blade second driving member 42, to magnetically hold the front blade second driving member 42 in the vicinity of the bottom end of the elongated hole 10b. Additionally, the rear blade electromagnet 72 contacts the iron piece member 54 of the rear blade second driving member 52, to magnetically hold the rear blade second driving member 52 in the vicinity of the bottom end of the elongated hole 10c.

The front blade electromagnet 71 has an essentially U-shaped core member, a coil (not shown), and the like. The core member has magnetic pole portions at the tip ends of the two leg portions. The coil is wound onto a bobbin that is fitted onto one of the leg portions of the coil member.

The coil member is excited by the application of a current to the coil. The excited core member produces a magnetic attracting force. The iron piece member 44 of the front blade second driving member 42 that is set in the vicinity of the bottom end of the elongated hole 10b (the setting position) is held on the core member by the magnetic attracting force of the core member. Through this, the front blade second driving member 42 is held at the setting position, against the biasing force of the front blade driving spring. On the other hand, stopping the electric current to the coil enables the counterclockwise rotation of the front blade second driving member 42 by the biasing force of the front blade driving spring. Note that in FIG. 2 through FIG. 8, only the core member is shown by the double dotted line as the front blade electromagnet 71.

The rear blade electromagnet 72, like front blade electromagnet 71, has a core member of an essentially U-shaped, and a coil (not shown).

A magnetic attracting force is produced in the core member through application of an electric current to the coil. The iron piece member 54 of the rear blade second driving member 52 that is set in the vicinity of the bottom end of the elongated hole 10c (the setting position) is held on the core member by the magnetic attracting force of the core member. Through this, the rear blade second driving member 52 is held at the setting position, against the biasing force of the rear blade driving spring. On the other hand, stopping the electric current to the coil enables the clockwise rotation of the rear blade second driving member 52 by the biasing force of the rear blade driving spring. Note that in FIG. 2 through FIG. 8, only the core member is shown by the double dotted line as the rear blade electromagnet 72.

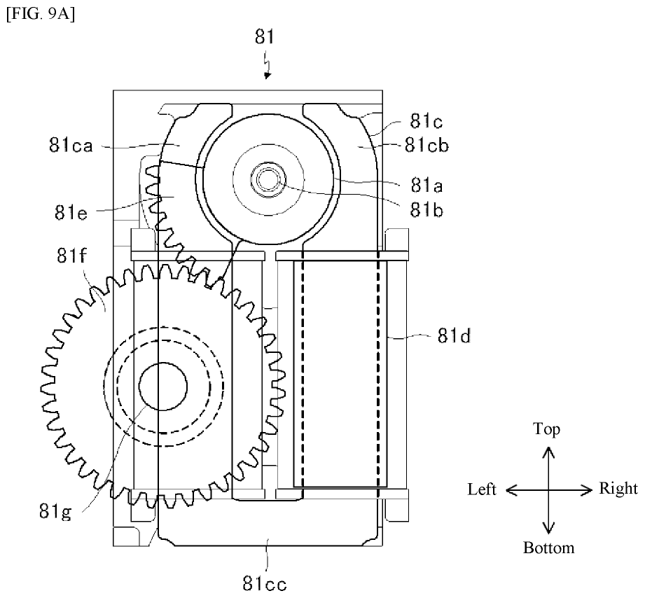

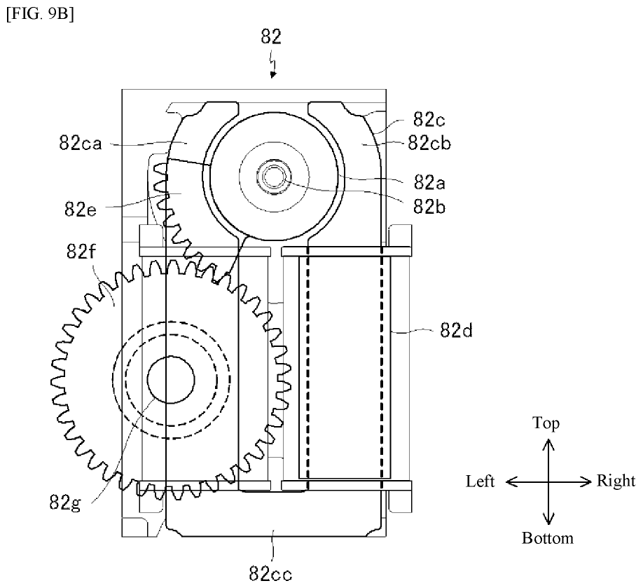

The first electromagnetic actuator 81 is a driving device for driving the front blade first driving member 41. The first electromagnetic actuator 81, as depicted in FIG. 9A, has a rotor 81a, a yoke 81c, a coil 81d, a driving gear 81e, and a follower gear 81f

The rotor 81a of the first electromagnetic actuator 81 is structured from a cylindrical magnet that is inserted into a rotary shaft 81b. The rotor 81a is magnetized with north poles and south poles alternating in the circumferential direction. The rotor 81a rotates centered on the rotary shaft 81b through changes in the magnetic field formed by the coil 81d.

The yoke 81c of the first electromagnetic actuator 81 is formed in a U shape from a magnetic material such as iron. The yoke 81c has a pair of leg piece portions 81ca and 81cb, and a connecting portion 81cc for connecting the pair of leg piece portions 81ca and 81cb. Arc-shaped recessed portions that correspond to the outer periphery of the rotor 81a are formed on the respective inner surfaces of the top end portions of the leg piece portions 81ca and 81cb. The recessed portions of the leg piece portions 81ca and the recessed portions of the leg piece portions 81cb are structured so as to encompass the outer periphery of the rotor 81a.

The coil 81d of the first electromagnetic actuator 81 is structured from windings formed from a conductive material, such as copper, or the like. The coil 81d is wound onto a portion of the yoke 81c (for example, the leg piece portion 81cb). The wound coil 81d excites the yoke 81c. Two connecting wires extend to the outside of the coil 81d from the winding, and are connected to a controlling device 5 of the imaging device 1. The yoke 81c is excited through the supply of current to the coil 81d through the lead wires from the controlling device 5.

The driving gear 81e of the first electromagnetic actuator 81 is a fan-shaped gear for relaying the rotation of the rotor 81a to the follower gear 81f. The driving gear 81e is provided so as to protrude in the radial direction from the outer peripheral portion of the rotor 81a. The driving gear 81e and the rotor 81a rotate together. Additionally, the driving gear 81e and the follower gear 81f mesh with each other. Consequently, the driving gear 81e is able to transmit the rotation of the rotor 81a to the follower gear 81f

The follower gear 81f of the first electromagnetic actuator 81 is a circular gear for transmitting the rotation of the rotor 81a to the front blade first driving member 41. The follower gear 81f is attached rotatably to a supporting shaft 81g that is provided within the first electromagnetic actuator 81. Additionally, the follower gear 81f and the driving gear 81e mesh with each other, and also the follower gear 81f meshes with a mating portion 41a of the front blade first driving member 41. The follower gear 81f rotates following rotation of the driving gear 81e, which rotates together with the rotor 81a, to transmit the rotation of the rotor 81a to the mating portion 41a of the front blade first driving member 41.

The second electromagnetic actuator 82 is a driving device for driving the rear blade first driving member 51. As depicted in FIG. 9B, the second electromagnetic actuator 82 has a rotor 82a, a yoke 82c, a coil 82d, a driving gear 82e, and a follower gear 82f. The structure of the various portions of the second electromagnetic actuator 82 are identical to those of the first electromagnetic actuator 81, and explanations for the parts that are in common will be omitted. Explanations will be for only those parts that are different between the second electromagnetic actuator 82 and the first electromagnetic actuator 81.

A driving gear 82e is provided on the rotor 82a. The driving gear 82e and the rotor 81a rotate together integrally. Additionally, the driving gear 82e and the follower gear 82f mesh with each other. Consequently, the driving gear 82e transmits the rotation of the rotor 82a to the follower gear 82f. The follower gear 82f is attached rotatably to a supporting shaft 82g that is provided within the second electromagnetic actuator 82. The follower gear 82f and the driving gear 82e mesh with each other, and also the follower gear 82f meshes with a mating portion 51a of the rear blade first driving member 51. The follower gear 82f rotates following rotation of the driving gear 82e, which rotates together with the rotor 82a, to transmit the rotation of the rotor 82a to the mating portion 51a of the rear blade first driving member 51.

The operation of the focal plane shutter 100 will be explained next. In the present example, the focal plane shutter 100 can be operated unit two driving modes. One is a first driving mode that carries out the exposing operation and the setting operation using the first electromagnetic actuator 81 and the second electromagnetic actuator 82. The other is a second driving mode that carries out the exposing operation and the setting operation using the first electromagnetic actuator 81 and the second electromagnetic actuator 82 supplementarily.

The first driving mode, wherein the exposing operation and the setting operation are performed using only the first electromagnetic actuator 81 and the second electromagnetic actuator 82, will be explained first. In the first driving mode, the front blade second driving member 42 and the rear blade second driving member 52, and the setting member 60, are not used. Consequently, the front blade second driving member 42 and the rear blade second driving member 52 are not held, respectively, by the front blade electromagnet 71 and the rear blade electromagnet 72 through application of electric currents to the front blade electromagnet 71 and the rear blade electromagnet 72.

(Normally-Open Mode)

Imaging in the normally-open mode, when in the first driving mode, will be explained below in reference to FIG. 4 through FIG. 6.

(Initial State)

FIG. 4 depicts the initial state, prior to beginning of imaging, in imaging using the normally-open mode. As illustrated in FIG. 4, in the initial state the front blade 20 and the rear blade 30 are closed. Consequently, the exposure opening 10a of the shutter base plate 10 is in a state that is open. The front blade first driving member 41 is in a state wherein the driving pin 41c is in contact with the shock absorbing material 12 that is provided at the top end portion of the elongated hole 10b. Additionally, the rear blade first driving member 51 is in a state wherein the driving pin 51c is at the bottom end portion of the elongated hole 10c. The front blade second driving member 42 and the rear blade second driving member 52 are locked, through retention of the setting member 60 at the setting position. Consequently, the state is one wherein rotation of the front blade second driving member 42 and of the rear blade second driving member 52 in the counterclockwise direction is prevented.

(Movement of the Front Blade)

In the initial state, when the release button of the imaging device 1 that is equipped with the focal plane shutter 100 is pressed, the controlling device 5 of the imaging device 1 supplies a current of a first direction to the coil 81d of the first electromagnetic actuator 81. Here the “first direction” is the direction of flow of the current in the coil 81d for causing the rotor 81a of the first electromagnetic actuator 81 to rotate in the counterclockwise direction.

When the electric current of the first direction is supplied to the coil 81d, the coil 81d and the yoke 81c become an electromagnet. A magnetic pole is formed at the periphery of the rotor 81a. Through this, a repelling force or an attracting force that is produced between the magnetic poles rotates of the rotor 81a and the driving gear 81e in the counterclockwise direction. Additionally, the follower gear 81f, which meshes with the driving gear 81e, rotates in the clockwise direction through rotation of the driving gear 81e in the counterclockwise direction.

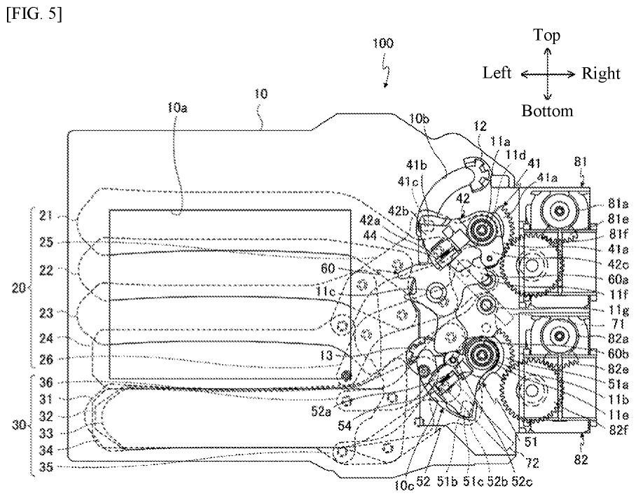

The rotation of the follower gear 81f in the clockwise direction is transmitted to the front blade first driving member 41 through the mating portion 41a. The front blade first driving member 41 to which this rotation has been transmitted rotates in the counterclockwise direction around the supporting shaft 11a. Through this, as illustrated in FIG. 5, the driving pin 41c moves from the top end to the bottom end of the elongated hole 10b. Additionally, the blades 21 through 24 of the front blade 20 move in the downward direction, while reducing the amount of overlap between adjacent blades, to close the exposure opening 10a. The movement of the front blade is completed through the above.

(Front Blade Exposing Operation)

Following this, the controlling device 5 stops the supply of current to the coil 81d, and switches the direction of the current that is supplied to the coil 81d. That is, the controlling device 5 supplies a current in a second direction, the direction that is opposite that of the first direction, to the coil 81d. Here the “second direction” is the direction of flow of the current in the coil 81d for causing the rotor 81a of the first electromagnetic actuator 81 to rotate in the clockwise direction.

Through this, the rotor 81a and the driving gear 81e rotate in the clockwise direction. Additionally, the follower gear 81f is rotated in the counterclockwise direction through rotation of the driving gear 81e in the clockwise direction.

The rotation of the follower gear 81f in the counterclockwise direction is transmitted to the front blade first driving member 41 through the mating portion 41a. The front blade first driving member 41 to which this rotation has been transmitted rotates in the clockwise direction around the supporting shaft 11a. Through this, as illustrated in FIG. 4, the driving pin 41c moves from the bottom end to the top end of the elongated hole 10b. Additionally, the blades 21 through 24 of the front blade 20 move in the upward direction, while increasing the amount of overlap between adjacent blades, to open the exposure opening 10a. The front blade exposing operation is completed through the above.

(Rear Blade Exposing Operation)

After a prescribed amount of time has elapsed after the beginning of the supply of the electric current of the second direction to the coil 81d, then next the controlling device 5 supplies an electric current of the second direction to the coil 82d of the second electromagnetic actuator 82. Through this, the rotor 82a and the driving gear 82e rotate in the clockwise direction. Additionally, the follower gear 82f is rotated in the counterclockwise direction through rotation of the driving gear 82e in the clockwise direction.

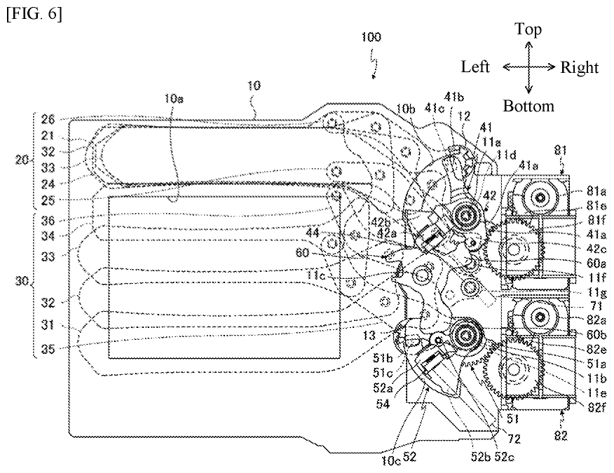

The rotation of the follower gear 82f in the counterclockwise direction is transmitted to the rear blade first driving member 51 through the mating portion 51a. The rear blade first driving member 51 to which this rotation has been transmitted rotates in the clockwise direction around the supporting shaft 11b. Through this, as illustrated in FIG. 6, the driving pin 51c moves from the bottom end to the top end of the elongated hole 10c. Additionally, the blades 31 through 34 of the rear blade 30 move in the upward direction, while reducing the amount of overlap between adjacent blades, to close the exposure opening 10a. The rear blade exposing operation is completed through the above.

(Setting Operation)

An image of the photographic subject is captured by the imaging element 3 of the imaging device 1 over the interval from the beginning of the front blade exposing operation until the completion of the rear blade exposing operation. When the rear blade exposing operation has been completed, then, in order to prepare for capturing the next image, an operation to set the rear blade first driving member 51 is performed. The controlling device 5 stops the supply of the electric current to the coil 82d of the second electromagnetic actuator 82, and switches the direction of the electric current that is supplied to the coil 82d. That is, the controlling device 5 supplies an electric current of the first direction to the coil 82d. Through this, the rotor 82a and the driving gear 82e rotate in the counterclockwise direction. Additionally, the follower gear 82f is rotated in the clockwise direction through rotation of the driving gear 82e in the counterclockwise direction.

The rotation of the follower gear 81f in the clockwise direction is transmitted to the rear blade first driving member 51 through the mating portion 51a. The rear blade first driving member 51 to which this rotation has been transmitted rotates in the counterclockwise direction around the supporting shaft 11b. The driving pin 51c is moved from the top end to the bottom end of the elongated hole 10b thereby. Additionally, the blades 31 through 34 of the rear blade 30 move in the downward direction, while increasing the amount of overlap between adjacent blades, to open the exposure opening 10a. The setting operation is completed through the above, returning the focal plane shutter 100 to the initial state for imaging in the normally-open mode, depicted in FIG. 4.

(Normally-Closed Mode)

Imaging in the normally-closed mode, when in the first driving mode, will be explained below in reference to FIG. 4 through FIG. 6.

(Initial State)

FIG. 5 depicts the initial state, prior to beginning of imaging, in imaging using the normally-closed mode. As illustrated in FIG. 5, in the initial state the front blade 20 is open and the rear blade 30 is closed. Consequently, the exposure opening 10a of the shutter base plate 10 is in a state that is closed. The front blade first driving member 41 is in a state wherein the driving pin 41c is at the bottom end portion of the elongated hole 10b. Additionally, the rear blade first driving member 51 is in a state wherein the driving pin 51c is at the bottom end portion of the elongated hole 10c. The front blade second driving member 42 and the rear blade second driving member 52 are locked, through retention of the setting member 60 at the setting position. Consequently, the state is one wherein rotation of the front blade second driving member 42 and of the rear blade second driving member 52 in the counterclockwise direction is prevented.

(Front Blade Exposing Operation)

In the initial state, when the release button of the imaging device 1 that is equipped with the focal plane shutter 100 is pressed, the controlling device 5 of the imaging device 1 supplies a current of a second direction to the coil 81d of the first electromagnetic actuator 81. Through this, the rotor 81a and the driving gear 81e rotate in the clockwise direction. Additionally, the follower gear 81f is rotated in the counterclockwise direction through rotation of the driving gear 81e in the clockwise direction.

The rotation of the follower gear 81f in the counterclockwise direction is transmitted to the front blade first driving member 41 through the mating portion 41a. The front blade first driving member 41 to which this rotation has been transmitted rotates in the clockwise direction around the supporting shaft 11a. Through this, as illustrated in FIG. 4, the driving pin 41c moves from the bottom end to the top end of the elongated hole 10b. Additionally, the blades 21 through 24 of the front blade 20 move in the upward direction, while increasing the amount of overlap between adjacent blades, to open the exposure opening 10a. The front blade exposing operation is completed through the above.

(Rear Blade Exposing Operation)

After a prescribed amount of time has elapsed after the beginning of the supply of the electric current of the second direction to the coil 81d, then next the controlling device 5 supplies an electric current of the second direction to the coil 82d of the second electromagnetic actuator 82. Through this, the rotor 82a and the driving gear 82e rotate in the clockwise direction. Additionally, the follower gear 82f is rotated in the counterclockwise direction through rotation of the driving gear 82e in the clockwise direction.

The rotation of the follower gear 82f in the counterclockwise direction is transmitted to the rear blade first driving member 51 through the mating portion 51a. The rear blade first driving member 51 to which this rotation has been transmitted rotates in the clockwise direction around the supporting shaft 11b. Through this, as illustrated in FIG. 6, the driving pin 51c moves from the bottom end to the top end of the elongated hole 10c. Additionally, the blades 31 through 34 of the rear blade 30 move in the upward direction, while reducing the amount of overlap between adjacent blades, to close the exposure opening 10a. The rear blade exposing operation is completed through the above.

(Setting Operation)

An image of the photographic subject is captured by the imaging element 3 of the imaging device 1 over the interval from the beginning of the front blade exposing operation until the completion of the rear blade exposing operation. When the rear blade exposing operation has been completed, then, in order to prepare for capturing the next image, an operation to set the front blade first driving member 41 and the rear blade first driving member 51 is performed. The controlling device 5 stops the supply of the electric current to the coil 82d, and switches the direction of the electric current that is supplied to the coil 82d. That is, the controlling device 5 supplies an electric current of the first direction to the coil 82d. Through this, the rotor 82a and the driving gear 82e rotate in the counterclockwise direction. Additionally, the follower gear 82f is rotated in the clockwise direction through rotation of the driving gear 82e in the counterclockwise direction.

The rotation of the follower gear 82f in the clockwise direction is transmitted to the rear blade first driving member 51 through the mating portion 51a. The rear blade first driving member 51 to which this rotation has been transmitted rotates in the counterclockwise direction around the supporting shaft 11b. The driving pin 51c is moved from the top end to the bottom end of the elongated hole 10c thereby. Additionally, the blades 31 through 34 of the rear blade 30 move in the downward direction, while increasing the amount of overlap between adjacent blades.

On the other hand, the controlling device 5 supplies electric current of the first direction to the coil 81d of the first electromagnetic actuator 81. The rotor 81a and the driving gear 81e rotate in the counterclockwise direction when the current of the first direction is supplied to the coil 81d. Additionally, the follower gear 81f is rotated in the clockwise direction through the rotation of the driving gear 81e in the counterclockwise direction, so that the front blade first driving member 41 will rotate in the counterclockwise direction centered on the supporting shaft 11a. Additionally, the driving pin 41c is moved from the top end to the bottom end of the elongated hole 10b. Additionally, the blades 21 through 24 of the front blade 20 move in the downward direction, while reducing the amount of overlap between adjacent blades, to close the exposure opening 10a. The setting operation is completed through the above, returning the focal plane shutter 100 to the initial state for imaging in the normally-closed mode, depicted in FIG. 5.

(Front Curtain Electronic Shutter Mode)

Imaging in the front curtain electronic shutter mode, when in the first driving mode, will be explained next in reference to FIG. 4 and FIG. 6. In the front curtain electronic shutter mode, when the front blade 20 and the rear blade 30 are in a state wherein the exposure opening 10a is open, the controlling device 5 of the imaging device 1 controls the imaging element 3, to perform an exposing operation, in the imaging element 3, corresponding to the front blade exposing operation. Following this, the rear blade 30 closes the exposure opening 10a.

(Initial State)

FIG. 4 is a diagram depicting the initial state prior to the beginning of imaging in the front curtain shutter mode. As illustrated in FIG. 4, in the initial state the front blade 20 and the rear blade 30 are closed. Consequently, the exposure opening 10a of the shutter base plate 10 is in a state that is open. The front blade first driving member 41 is in a state wherein the driving pin 41c is in contact with the shock absorbing material 12 that is provided at the top end portion of the elongated hole 10b. The rear blade first driving member 51 is in a state wherein the driving pin 51c is at the bottom end portion of the elongated hole 10c. Additionally, the front blade second driving member 42 and the rear blade second driving member 52 are locked, through retention of the setting member 60 at the setting position. Consequently, the state is one wherein rotation of the front blade second driving member 42 and of the rear blade second driving member 52 in the counterclockwise direction is prevented.

(Exposing Operation)

In the initial state, when the release button of the imaging device 1 in which the focal plane shutter 100 is equipped is pressed, the imaging element 3 of the imaging device 1 performs an exposing operation, corresponding to the front blade exposing operation, through control by the controlling device 5. An image of the photographic subject is captured thereby.

When a prescribed time, which depends on the brightness of the imaging subject, has elapsed, the controlling device 5 supplies a current of the second direction to the coil 82d of the second electromagnetic actuator 82. Through this, the rotor 82a and the driving gear 82e rotate in the clockwise direction. Additionally, the follower gear 82f is rotated in the counterclockwise direction through rotation of the driving gear 82e in the clockwise direction.

The rotation of the follower gear 82f in the counterclockwise direction is transmitted to the rear blade first driving member 51 through the mating portion 51a. The rear blade first driving member 51 to which this rotation has been transmitted rotates in the clockwise direction around the supporting shaft 11b. Through this, as illustrated in FIG. 6, the driving pin 51c moves from the bottom end to the top end of the elongated hole 10c. Additionally, the blades 31 through 34 of the rear blade 30 move in the upward direction, while reducing the amount of overlap between adjacent blades, to close the exposure opening 10a. The exposing operation is completed through the above.

(Setting Operation)

When the rear blade exposing operation has been completed, then, in order to prepare for capturing the next image, an operation to set the rear blade first driving member 51 is performed. The controlling device 5 supplies an electric current of the first direction to the coil 82d. Through this, the rotor 82a and the driving gear 82e rotate in the counterclockwise direction. Additionally, the follower gear 82f is rotated in the clockwise direction through rotation of the driving gear 82e in the counterclockwise direction.

The rotation of the follower gear 82f in the clockwise direction is transmitted to the rear blade first driving member 51 through the mating portion 51a. The rear blade first driving member 51 to which this rotation has been transmitted rotates in the counterclockwise direction around the supporting shaft 11b. The driving pin 51c is moved from the top end to the bottom end of the elongated hole 10c thereby. Additionally, the blades 31 through 34 of the rear blade 30 move in the downward direction, while increasing the amount of overlap between adjacent blades, to open the exposure opening 10a. The setting operation is completed through the above, returning the focal plane shutter 100 to the initial state for imaging in the front curtain shutter mode, depicted in FIG. 4.

A second driving mode wherein the first electromagnetic actuator 81 and the second electromagnetic actuator 82 are used supplementarily will be explained next. In the second driving mode, the focal plane shutter 100 performs the exposing operation using the front blade second driving member 42 and the rear blade second driving member 52. In the focal plane shutter 100, the setting member 60 is used to set the front blade second driving member 42 and the rear blade second driving member 52 to the setting position (setting operation). In the focal plane shutter 100, in the exposing operation and the setting operation, the front blade first driving member 41 and the rear blade first driving member 51 are driven by the first electromagnetic actuator 81 and the second electromagnetic actuator 82 so as to link the front blade second driving member 42 and the rear blade second driving member 52 to the operation of the setting member 60.

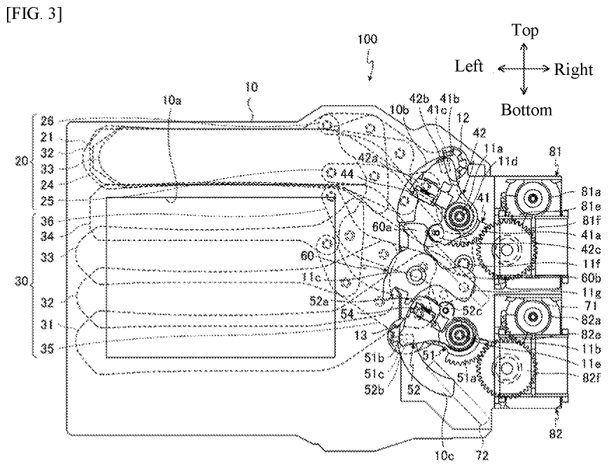

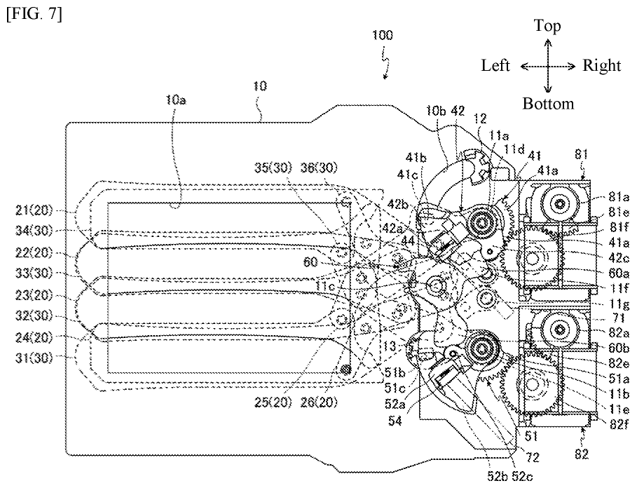

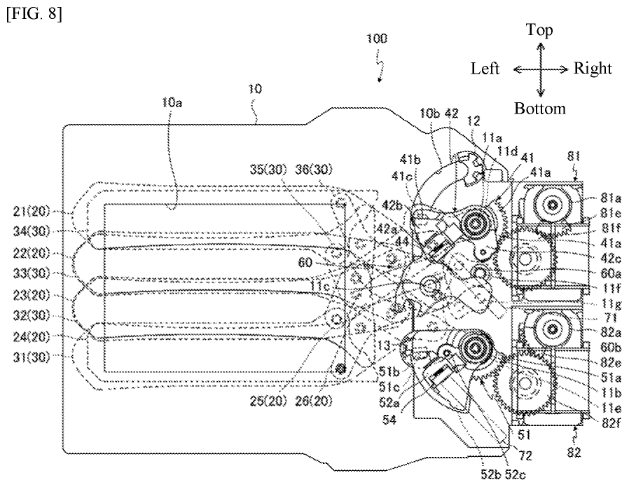

For the operation in the second driving mode, imaging in the normally-closed mode will be explained, as a typical example, referencing FIG. 2, FIG. 3, FIG. 7, in FIG. 8 below.

(Completion of the Exposing Operation)

FIG. 3 is a diagram depicting the state when the exposing operation has been completed in imaging in the normally-closed mode. As illustrated in FIG. 3, when the exposing operation has been completed, the front blade 20 is closed and the rear blade 30 is exposed. Consequently, the exposure opening 10a of the shutter base plate 10 is in a state that is closed. The front blade first driving member 41 is in a state wherein the driving pin 41c is in contact with the shock absorbing material 12, positioned at the top end portion of the elongated hole 10b. The rear blade first driving member 51 is in a state wherein the driving pin 51c is in contact with the shock absorbing material 13, positioned at the top end portion of the elongated hole 10c. The state is one wherein rotation of the front blade second driving member 42 and of the rear blade second driving member 52 in the counterclockwise direction is stopped.

(Setting Operation)

In order to prepare for capturing the next image, the setting member 60 applies a driving force (performs charging) to the front blade second driving member 42 and the rear blade second driving member 52, to perform a setting operation that locks the front blade second driving member 42 and the rear blade second driving member 52. As illustrated in FIG. 7, the setting member 60 is rotated in the clockwise direction by a driving mechanism. In this case, the first engaging portion 60a of the setting member 60 pushes the engaged portion 42c of the front blade second driving member 42. Additionally, the second engaging portion 60b of the setting member 60 pushes the engaged portion 52c of the rear blade second driving member 52. Through this, the front blade second driving member 42 is rotated in the counterclockwise direction against the biasing force of the front blade driving spring. Additionally, the rear blade second driving member 52 is rotated in the counterclockwise direction against the biasing force of the rear blade driving spring. When the setting position has been reached, rotation of the setting member 60 in the counterclockwise direction is stopped by the driving mechanism. Additionally, the setting member 60 is held in the setting position by the driving mechanism. In this case, the first engaging portion 60a of the setting member 60 engages the engaged portion 42c of the front blade second driving member 42. Additionally, the second engaging portion 60b of the setting member 60 engages the engaged portion 52c of the rear blade second driving member 52. In this way, the front blade second driving member 42 and the rear blade second driving member 52 are set to the setting position in a state wherein a driving force is applied for causing operation of the front blade 20 and the rear blade 30.

Additionally, the controlling device 5 supplies electric current of the first direction to the coil 81d of the first electromagnetic actuator 81. The rotor 81a and the driving gear 81e rotate in the counterclockwise direction when the current of the first direction is supplied to the coil 81d. Additionally, the follower gear 81f is rotated in the clockwise direction through the rotation of the driving gear 81e in the counterclockwise direction, so that the front blade first driving member 41 will rotate in the counterclockwise direction centered on the supporting shaft 11a. Additionally, the driving pin 41c is moved from the top end to the bottom end of the elongated hole 10b. Additionally, the blades 21 through 24 of the front blade 20 move in the downward direction, while reducing the amount of overlap between adjacent blades. Through this, a state will be produced wherein the front blade 20 is deployed, as depicted in FIG. 7. The setting operation is completed through the above. Given this, the focal plane shutter 100 stands by in the state wherein the setting operation has been completed (a standby state), until the release button of the imaging device 1 in which the focal plane shutter 100 is installed is pressed.

(Beginning of Imaging)

### (Holding of the Front Blade Second Driving Member and Rear Blade Second Driving Member)

When the release button of the imaging device 1 is pressed, an electric current to the front blade electromagnet 71 and the rear blade electromagnet 72 is started. Through this, the front blade second driving member 42 and rear blade second driving member 52 are held by the front blade electromagnet 71 and the rear blade electromagnet 72. The holding of the front blade second driving member and the rear blade second driving member is completed thereby.

(Retraction of the Setting Member)

When the front blade second driving member 42 and the rear blade second driving member 52 are held on the front blade electromagnet 71 and the rear blade electromagnet 72, the driving mechanism releases the retention of the setting member 60. When the retention by the driving mechanism is released, the setting member 60 retracts from the setting position to the initial position through rotation in the counterclockwise direction by the biasing force of the biasing spring, as illustrated in FIG. 8. Through this, the engagement of the front blade second driving member 42 and the rear blade second driving member 52 is released. In this case, the front blade second driving member 42 and the rear blade second driving member 52 are held by the front blade electromagnet 71 and the rear blade electromagnet 72, and thus rotation of the front blade second driving member 42 and of the rear blade second driving member 52 in the counterclockwise direction is prevented. The retraction of the setting member is completed thereby.

(Movement of the Rear Blade)

Following this, the controlling device 5 supplies an electric current of the first direction to the coil 82d of the second electromagnetic actuator 82. Through this, the rotor 82a and the driving gear 82e rotate in the counterclockwise direction. Additionally, the follower gear 82f is rotated in the clockwise direction through rotation of the driving gear 82e in the counterclockwise direction.

The rotation of the follower gear 82f in the clockwise direction is transmitted to the rear blade first driving member 51 through the mating portion 51a. The rear blade first driving member 51 to which this rotation has been transmitted rotates in the counterclockwise direction around the supporting shaft 11b.

Through this, as illustrated in FIG. 2, the driving pin 51c moves from the top end to the bottom end of the elongated hole 10c. Additionally, the blades 31 through 34 of the rear blade 30 move in the downward direction, while increasing the amount of overlap between adjacent blades. The movement of the rear blades is completed thereby.

(Front Blade Exposing Operation)

Following this, the controlling device 5 supplies an electric current of the second direction to the coil 81d of the first electromagnetic actuator 81. Through this, the front blade first driving member 41 rotates in the clockwise direction around the supporting shaft 11a.

Additionally, the electric current to the front blade electromagnet 71 is stopped essentially simultaneously with the start of the rotation of the front blade first driving member 41 in the clockwise direction by the first electromagnetic actuator 81. When the supply of electric current to the front blade electromagnet 71 is stopped, the magnetic attracting force on the front blade second driving member 42 is lost, releasing the restraint on the rotation of the front blade second driving member 42 in the clockwise direction. Through this, the front blade second driving member 42 begins to rotate in the clockwise direction, centered on the supporting shaft 11a, through the biasing force of a front blade driving spring. Given this, the pushing portion 42b of the front blade second driving member 42 pushes the pushed portion 41b of the front blade first driving member 41, so that the front blade second driving member 42 rotates together with the front blade first driving member 41.

In this way, the front blade first driving member 41 begins to rotate in the clockwise direction essentially simultaneously with the front blade second driving member 42. Consequently, the front blade second driving member 42 is able to rotate in the clockwise direction together with the front blade first driving member 41, without receiving any effect that would restrain rotation due to detent torque of the rotor 81a. Moreover, the first electromagnetic actuator 81 causes the front blade first driving member 41 to rotate in the same direction as the front blade second driving member 42. Consequently, the first electromagnetic actuator 81 is able to assist in the rotation of the front blade second driving member 42 that pushes the front blade first driving member 41.

The driving pin 41c moves from the bottom end to the top end of the elongated hole 10b through rotation of the front blade second driving member 42 of together with the front blade first driving member 41. Additionally, the blades 21 through 24 of the front blade 20 move in the upward direction, while increasing the amount of overlap between adjacent blades, to open the exposure opening 10a. The front blade exposing operation is completed through the above.

(Rear Blade Exposing Operation)

Following this, after a prescribed amount of time has elapsed after the electric current to the front blade electromagnet 71 has been stopped, the controlling device 5 supplies an electric current of the second direction to the coil 82d of the second electromagnetic actuator 82. Through this, the rear blade first driving member 51 rotates in the clockwise direction around the supporting shaft 11b.

Additionally, the electric current to the rear blade electromagnet 72 is stopped essentially simultaneously with the start of the rotation of the rear blade first driving member 51 in the clockwise direction by the second electromagnetic actuator 82. When the supply of electric current to the rear blade electromagnet 72 is stopped, the magnetic attracting force on the rear blade second driving member 52 is lost, releasing the restraint on the rotation of the rear blade second driving member 52 in the clockwise direction. Through this, the rear blade second driving member 52 begins to rotate in the clockwise direction, centered on the supporting shaft 11b, through the biasing force of a rear blade driving spring. Given this, the pushing portion 52b of the rear blade second driving member 52 pushes the pushed portion 51b of the rear blade first driving member 51, so that the rear blade second driving member 52 rotates together with the rear blade first driving member 51.

In this way, the rear blade first driving member 51 begins to rotate in the clockwise direction essentially simultaneously with the rear blade second driving member 52. Consequently, the rear blade second driving member 52 is able to rotate in the clockwise direction together with the rear blade first driving member 51, without receiving any effect that would restrain rotation due to detent torque of the rotor 82a. Moreover, the second electromagnetic actuator 82 causes the rear blade first driving member 51 to rotate in the same direction as the rear blade second driving member 52. Consequently, the second electromagnetic actuator 82 is able to assist in the rotation of the rear blade second driving member 52 that pushes the rear blade first driving member 51.

The driving pin 51c moves from the bottom end to the top end of the elongated hole 10c through rotation of the rear blade second driving member 52 of together with the rear blade first driving member 51, as depicted in FIG. 3. Additionally, the blades 31 through 34 of the rear blade 30 move in the upward direction, while reducing the amount of overlap between adjacent blades, to close the exposure opening 10a. The rear blade exposing operation is completed through the above, returning the focal plane shutter 100 to the state at the completion of the exposing operation when imaging in the normally-closed mode, depicted in FIG. 3. An image of the photographic subject is captured by the imaging element 3 of the imaging device 1 over the interval from the beginning of the front blade exposing operation until the completion of the rear blade exposing operation.

As explained above, the focal plane shutter 100 according to the present example is equipped with a first electromagnetic actuator 81 for driving the front blade first driving member 41 that is coupled to the front blade 20, and a second electromagnetic actuator 82 for driving the rear blade first driving member 51 that is coupled to the rear blade 30. The focal plane shutter 100 can carry out imaging in a normally-open mode, a normally-closed mode, and a front curtain electronic shutter mode. The focal plane shutter 100, in a first driving mode, uses the front blade second driving member 42 that causes following rotation of the front blade first driving member 41 that is coupled to the front blade 20. Consequently, in the first driving mode of the focal plane shutter 100, it is not necessary for the front blade driving spring to be strong in order to rotate the front blade first driving member 41 against the biasing force of the set spring that is provided in a first driving member of the conventional focal plane shutter. Additionally, there is no need for the front blade driving spring to be strong in order to improve the shutter performance. Furthermore, there is no need for the attracting force of the front blade electromagnet 71 for holding the front blade second driving member 42 to be strong. Because the rear blade second driving member 52 is also not used, there is no need for the rear blade driving spring to be strong like the front blade driving spring. There is no need for the attracting force of the rear blade electromagnet 72 to be strong.

Moreover, in the front blade movement in the normally-open mode in the focal plane shutter 100, the front blade 20 is moved by the first electromagnetic actuator 81, which has a driving force that is stronger than the biasing force of the set spring in the conventional focal plane shutter. Consequently, the focal plane shutter 100 enables an improvement in shutter performance, through shortening the time lag between pressing of the release button and the front blade exposing operation. Furthermore, in the first driving mode the setting operation is not performed by the setting member 60. Consequently, the focal plane shutter 100, in the first mode, is able to eliminate operations such as charging the driving force by the setting member 60, and retraction of the setting member 60, enabling an improvement in shutter performance. Through this, the focal plane shutter 100 enables an increase in speed of continuous shooting by the imaging device 1 in which the focal plane shutter 100 is provided. Furthermore, the focal plane shutter 100 is able to shorten the release time lag of the imaging device 1 in which the focal plane shutter 100 is provided.

In the focal plane shutter 100, in an exposing operation in the second mode, the front blade first driving member 41 and rear blade first driving member 51 rotate together with the rotation of the front blade second driving member 42 and the rear blade second driving member 52, through the first electromagnetic actuator 81 and the second electromagnetic actuator 82. Through this, the first electromagnetic actuator 81 and the second electromagnetic actuator 82 can not only reduce the motion starting load of the front blade 20 and the rear blade 30, but can also assist in moving the front blade 20 and the rear blade 30. Moreover, the focal plane shutter 100 is able to move the front blade second driving member 42 and the rear blade second driving member 52 more quickly, through the assistance of the first electromagnetic actuator 81 and the second electromagnetic actuator 82, enabling the speed of movement of the front blade 20 and of the rear blade 30 to be faster.

As with the first driving mode, in the focal plane shutter 100, the front blade 20 can be moved by the first electromagnetic actuator 81 that has a driving force that is stronger than the biasing force of the conventional set spring. The result is that the focal plane shutter 100 can shorten the time lag between pressing of the release button and the front blade exposing operation in the normally-open mode of the second driving mode. Moreover, the focal plane shutter 100 is not equipped with the set spring that is provided in the conventional focal plane shutter, so there is no need for the front blade driving spring and the rear blade driving spring to be strong in order to overcome the biasing force of the set spring. Consequently, the focal plane shutter 100 enables achievement of application of the driving force to the front blade second driving member 42 and the rear blade second driving member 52 at a higher speed (high-speed charging) through rotating the front blade second driving member 42 and the rear blade second driving member 52 at a higher speed through rotation of the setting member 60. Furthermore, in the setting operation in the normally-closed mode, the focal plane shutter 100 enables achievement of high-speed charging of the front blade second driving member 42 through rotating the front blade second driving member 42 at a higher speed through rotation of the setting member 60, because the front blade first driving member 41 can be caused to follow the front blade second driving member 42 that is rotated at a high speed through the strong driving force of the first electromagnetic actuator 81.

In the conventional focal plane shutter, when switching from the standby state for the normally-closed mode to the normally-open mode or the front curtain electronic shutter mode, it is necessary to apply again a driving force to the second driving member, through a setting operation, after causing the front blade to open the exposure opening through rotating the first driving member together with the second driving member in the direction that is opposite of the biasing direction of the set spring, doing so through a biasing force of a driving spring. In the present example, in the focal plane shutter 100 the exposure opening 10a is opened by driving of the front blade 20 by the first electromagnetic actuator 81, thus enabling switching easily and quickly from the normally-closed mode to the normally-open mode or the front curtain electronic shutter mode, without performing a setting operation.

As described above, in the focal plane shutter 100, in the second driving mode as well, the biasing force of the driving spring and the attracting forces of the front blade electromagnet 71 and the rear blade electromagnet 72 are not strong, enabling an improvement in the shutter performance. Moreover, the focal plane shutter 100 can increase the shutter speed, and the speed of continuous shooting, and the like, of the imaging device 1 in which the focal plane shutter 100 is equipped.

In the present example, the rotor 81a of the first electromagnetic actuator 81 and the front blade first driving member 41 are connected through the driving gear 81e and the follower gear 81f, in order to transmit the driving force of the first electromagnetic actuator 81 to the front blade first driving member 41. However, the driving force of the first electromagnetic actuator 81 may instead be transmitted directly to the front blade first driving member 41. For example, an arm that rotates integrally with the rotor 81a of the first electromagnetic actuator 81 may be provided, and the arm and the front blade first driving member 41 may be connected. Moreover, the driving force of the second electromagnetic actuator 82 may be transmitted directly to the rear blade first driving member 51.

Moreover, the first electromagnetic actuator 81 and the second electromagnetic actuator 82 may assist in braking of the front blade 20 and the rear blade 30. For example, the first electromagnetic actuator 81 may cause the rotor 81a to rotate in the counterclockwise direction immediately prior to the driving pin 41c of the front blade first driving member 41 arriving at the shock absorbing material 12, through rotation of the front blade first driving member 41 in the clockwise direction. This applies a force in the counterclockwise direction through the driving gear 81e and the follower gear 81f to the front blade first driving member 41, thus enabling the first electromagnetic actuator 81 to brake the front blade 20 that is moving upward through the rotation of the front blade first driving member 41 in the clockwise direction.

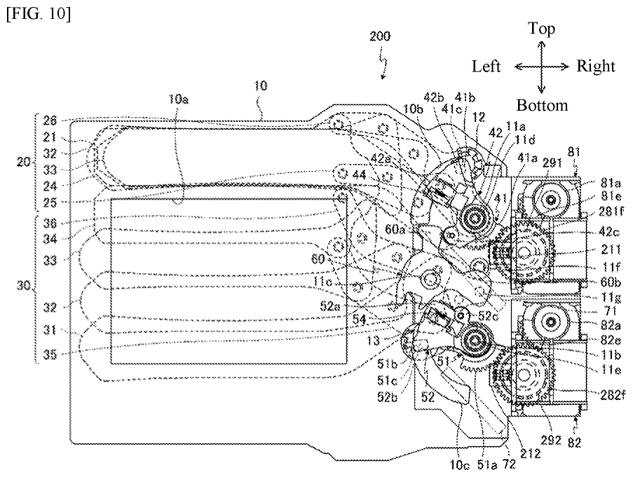

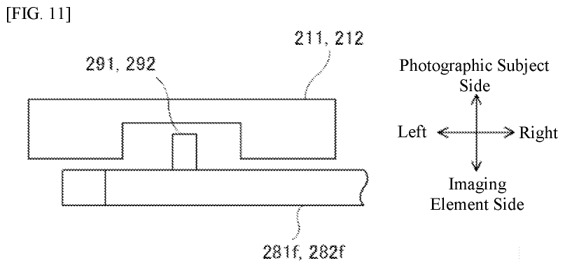

A focal plane shutter 200 according to another example according to the present invention, and an imaging device 1 equipped with the focal plane shutter 200 will be explained in reference to FIG. 1, FIG. 10, and FIG. 11.

As depicted in FIG. 10, in the focal plane shutter 200 follower gears 281f and 282f are provided instead of the follower gears 81f and 82f of the focal plane shutter 100 of the previous example. Additionally, the focal plane shutter 200 comprises a position sensor 211 for detecting the rotational position of the follower gear 281f, and a position sensor 212 for detecting the rotational position of the follower gear 282f The other structures are the same as in the focal plane shutter 100 of the previous example.

Additionally, as depicted in FIG. 1, the focal plane shutter 200 is provided in an imaging device 1 instead of the focal plane shutter 100. In the present example, the controlling portion 7 of the imaging device 1 controls the speed of movement of the front blade 20 based on the rotational position of the follower gear 281f, detected by the position sensor 211, and controls the speed of movement of the rear blade 30 based on the rotational position of the follower gear 282f, detected by the position sensor 212.

The follower gear 281f of the focal plane shutter 200 is structured from a circular gear having a plurality of protruding portions 291 on the face on the imaging subject side, as depicted in FIG. 10 and FIG. 11. The plurality of protruding portions 291 is provided with prescribed spacing along the circumferential direction of the follower gear 281f.

The follower gear 281f, as with the follower gear 81f of the focal plane shutter 100, is attached rotatably to a supporting shaft 81g of a first electromagnetic actuator 81. Moreover, the follower gear 281f and the driving gear 81e mesh together, and the follower gear 281f and the mating portion 41a of a front blade first driving member 41, mesh together. The follower gear 281f transmits, to the front blade first driving member 41, the rotation of the rotor 81a of the first electromagnetic actuator 81.

The follower gear 282f of the focal plane shutter 200, like the follower gear 281f, is structured from a circular gear having a plurality of protruding portions 292 on the face on the imaging subject side. The plurality of protruding portions 292 is provided along the circumferential direction of the follower gear 282f The follower gear 282f, as with the follower gear 82f of the focal plane shutter 100, is attached rotatably to a supporting shaft 82g of a second electromagnetic actuator 82. Moreover, the follower gear 282f and the driving gear 82e mesh together, and the follower gear 282f and the mating portion 51a of a rear blade first driving member 51, mesh together. The follower gear 282f transmits, to the rear blade first driving member 51, the rotation of the rotor 82a of the second electromagnetic actuator 82.

The position sensor 211 of the focal plane shutter 200 detects the rotational position of the follower gear 281f The position sensor 211 is structured from, for example, a transmissive photointerrupter. In the present example, the position sensor 211 detects the rotational position of the follower gear 281f from whether a detection beam passes through or is blocked by a protruding portion 291 of the follower gear 281f. The position sensor 211 is provided on the supporting plate of the focal plane shutter 200, in the same manner as with the front blade electromagnet 71.

The position sensor 212 of the focal plane shutter 200 detects the rotational position of the follower gear 282f. Like the position sensor 211, the position sensor 212 is structured from a transmissive photointerrupter. The position sensor 212 detects the rotational position of the follower gear 282f from whether a detection beam passes through or is blocked by a protruding portion 292 of the follower gear 282f The position sensor 212 is provided on the supporting plate.

The position sensor 211 and the position sensor 212 transmit, to the controlling portion 7 of the imaging device 1, a signal indicating that the detection beam is blocked and a signal indicating that the detecting beam is passed.

The control of the speeds of movement of the front blade 20 and of the rear blade 30 by the controlling portion 7 of the imaging device 1 will be explained next, using the front blade 20 as an example.

In a conventional focal plane shutter, there is a danger in that there will be a change, over time, in the speed of movement of the blade member due to changes over time in members, or the like, such as the blade member, the driving spring for biasing the driving member, the member that brakes the blade member, and the like. If there is a change in the speed of movement of a blade member, it becomes impossible for the blade member to move at a speed of movement that corresponds to a shutter speed or frame speed, or the like, of the imaging device, set by the user. Given this, it has been difficult for the user to capture a desired image of the photographic subject using an imaging device that is equipped with a conventional focal plane shutter.

In the imaging device 1 according to the present example, the controlling portion 7 controls the speed of movement of the front blade 20. Specifically, first, in the exposing operation of the front blade 20 (the front blade exposing operation), the position sensor 211 transmits, to the controlling portion 7, a signal indicating the blockage of a detection beam, and a signal indicating the transmission of the detection beam, by the protruding portions 291 of the follower gear 281f.

Following this, the controlling portion 7 calculates the speed of movement of the front blade 20, in the interval of the initial movement of the front blade 20, for example, from the signals that have been received and from the time measured by a timer. The initial movement interval of the front blade 20 is, for example, the interval of the first 1/5 of the total interval over which the front blade 20 moves during the front blade exposing operation. Moreover, because the follower gear 281f that meshes with the mating portion 41a of the front blade first driving member 41, which is connected to the front blade 20, the controlling portion 7 is able to calculate the position of the front blade 20 (for example, whether or not the position is within the initial movement interval) from the rotational position of the follower gear 281f, that is, from the signals that indicate that the detection beam is blocked and the signals that indicate that the detection beam is transmitted.

The controlling portion 7 compares the calculated speed of movement of the front blade 20 in the initial movement interval to the speed of movement of the front blade 20 during the initial movement interval, which has been stored in memory in advance. If the difference between the calculated speed of movement of the front blade 20 and the stored speed of movement of the front blade 20 is greater than a prescribed value, the controlling portion 7 increases or decreases the amount of electric current that is supplied to the first electromagnetic actuator 81 during the initial movement interval through the power supplying portion 9. Through this, the controlling portion 7 is able to control the speed of movement of the front blade 20 during the initial movement interval. For example, if the calculated speed of movement of the front blade 20 is slower than the speed of movement of the front blade 20 that has been stored in advance, then, in response to the difference in the speed of movement, the controlling portion 7 increases the amount of current that is supplied to the first electromagnetic actuator 81 during the initial movement interval. This makes it possible for the controlling portion 7 to increase the speed of movement of the front blade 20 during the initial movement interval.

Note that the controlling portion 7 can control the speed of movement of the rear blade 30 during the initial movement interval in the same manner as for the front blade 20.

As described above, the focal plane shutter 200 according to the present example can control the speed of movement of the front blade 20 and of the rear blade 30 based on the rotational position of the follower gear 281f, detected by the position sensor 211, and the rotational position of the follower gear 282f, detected by the position sensor 212, to thereby improve the shutter performance. Moreover, the focal plane shutter 200 is provided with a first electromagnetic actuator 81 and a second electromagnetic actuator 82, in the same manner as with the focal plane shutter 100 of the first example. Consequently, in the same manner as with the focal plane shutter 100, the focal plane shutter 200 is able to improve the shutter performance without increasing the biasing force of the driving spring or the attracting forces of the front blade electromagnet 71 and the rear blade electromagnet 72.

Moreover, the controlling portion 7 of the imaging device 1 according to the present example is able to control the speed of movement of the front blade 20 and of the rear blade 30. Through this, the imaging device 1 is able to cause the front blade 20 and the rear blade 30 to move at a speed of movement corresponding to the shutter speed, frame speed, or the like, that has been set by the user.

While in the present example the controlling portion 7 controls the speed of movement of the front blade 20 and the rear blade 30 during the initial movement interval, the controlling portion 7 may instead control the speed of movement during the entire interval over which the front blade 20 and the rear blade 30 move. For example, a protruding portion 291 for blocking the detection beam of a position sensor 211 at the rotational position corresponding to the setting position of the front blade 20, and a protruding portion 291 for blocking a detection beam of a position sensor 211 that is at a rotational position corresponding to the position when the exposing operation of the front blade 20 has been completed, are provided on the follower gear 281f. In this case, the controlling portion 7 is able to calculate the speed of movement over the entire interval over which the front blade 20 moves, from the signals indicating that the detection beam is blocked, and the time measured by a timer. Consequently, the controlling portion 7 is able to control the speed of movement over the entire interval of movement of the front blade 20, by increasing or decreasing the amount of electric current supplied to the first electromagnetic actuator 81, based on the speeds of movement calculated over the entire interval.

Furthermore, the controlling portion 7 may control the speed of movement of the front blade 20 and of the rear blade 30 during an interval immediately prior to completion of the exposing operation (for example, during the final 1/10 interval of the entire interval).

The numbers of protruding portions 291 and 292 provided on the follower gears 281f and 282f are arbitrary. Moreover, the position sensors 211 and 212 are not limited to being transmissive-type photointerrupter. The position sensors 211 and 212 may be, for example, reflective photosensors. When the position sensors 211 and 212 are structured from reflective photosensors, reflective layers are provided on the follower gears 281f and 282f instead of the protruding portions 291 and 292. Moreover, the position sensors 211 and 212 may detect the rotational positions of the driving gears 81e and 82e.

The present invention can have a variety of examples or modifications that do not deviate from the scope of the spirit of the broad definition of the present invention. Moreover, the examples set forth above are to explain this invention, and do not limit the scope of the present invention. That is, the scope of the present invention is defined by the claims, not the examples. Given this, various modifications that are within the patent claims, or within the scope of the broad meaning of the inventions that are equivalent thereto, are viewed as being within the scope of the invention.

The present application is based on Japanese Patent Application 2017-071949, filed on Mar. 31, 2017. The Specification, Claims, and Drawings of Japanese Patent Application 2017-071949 in are incorporated in their entirety, by reference, in this Specification.

1. A focal plane shutter comprising:
a blade member opening/closing an exposure opening that is formed in a base plate;
a first driving member coupled to the blade member; and
an electromagnetic actuator driving the first driving member.

2. The focal plane shutter as set forth in claim 1, further comprising:
a second driving member rotating, along with the first driving member, through the biasing force of a driving spring; and
a setting member setting the second driving member to a position for starting the exposing operation, against the biasing force of the driving spring.

3. The focal plane shutter as set forth in claim 2, wherein:
the electromagnetic actuator is configured so as to link the first driving member to actuation of the second driving member and the setting member.

4. The focal plane shutter as set forth in claim 1, wherein:
the electromagnetic actuator is structured so as to be coupled to the first driving member through one or more gears.

5. The focal plane shutter as set forth in claim 4, comprising:
a position sensor for detecting a rotational position of the one or more gears.

6. An imaging device, comprising:
a focal plane shutter as set forth in claim 1.

7. An imaging device, comprising:
a focal plane shutter as set forth in claim 5; and
a controlling portion for controlling a speed of movement of the blade member based on the rotational position detected by the position sensor.
